(19) United States
(12) Patent Application Publication
(10) Pub. No.: US 2025/0171084 A1
(43) Pub. Date: May 29, 2025

(54) VEHICLE LOWER PART STRUCTURE

(71) Applicant: TOYOTA JIDOSHA KABUSHIKI KAISHA, Toyota-shi (JP)

(72) Inventors: Satoru ABE, Okazaki-shi (JP); Yuzuru SHIOTA, Toyota-shi (JP); Tetsuo NURUKI, Toyota-shi (JP); Seiji ARAKAWA, Toyota-shi (JP); Kazusa ENDO, Toyota-shi (JP)

(73) Assignee: TOYOTA JIDOSHA KABUSHIKI KAISHA, Toyota-shi (JP)

(21) Appl. No.: 18/785,243

(22) Filed: Jul. 26, 2024

(30) Foreign Application Priority Data
Nov. 24, 2023 (JP) 2023-199427

(51) Int. Cl. B62D 21/15; B60K 1/04; B62D 25/02; H01M 50/242; H01M 50/249; H01M 50/271

(52) U.S. Cl. CPC B62D 21/152; B60K 1/04; B62D 25/025; H01M 50/242; H01M 50/249; H01M 50/271; B60K 2001/0444; H01M 2220/20

(57) ABSTRACT

An inclined rib is provided on a bottom wall of the battery case. The inclined rib transmits the collision load input from the vehicle front side to the rocker side, and the inclination transmits the collision load input from the vehicle rear side to the rocker side. That is, by providing the inclined rib in the bottom wall of the battery case, it is possible to secure the transmission path of the collision load (so-called front collision load or so-called rear collision load) input from the vehicle front side or the vehicle rear side.

### CROSS-REFERENCE TO RELATED APPLICATION

This application claims priority to Japanese Patent Application No. 2023-199427 filed on Nov. 24, 2023, incorporated herein by reference in its entirety.

### BACKGROUND

### 1. Technical Field

The present disclosure relates to a vehicle lower part structure.

### 2. Description of Related Art

In a battery electric vehicle described in CN114940214, a substantially rectangular parallelepiped battery housing space is defined by a space portion including a pair of right and left sill beams (sometimes referred to as rockers), a front cross member, a rear cross member, and a cooling plate. A plurality of batteries (battery pack) is housed in the battery housing space. In this related art, the floor of the vehicle is constituted by a cover plate that covers the top of the battery pack.

### SUMMARY

In the above related art, however, when a front impact load (collision load) is input to the battery pack including the batteries in the event of, for example, a front collision of the vehicle (hereinafter referred to as “vehicle front collision”), there is concern about a transmission path of the collision load.

In view of the above circumstances, it is an object of the present disclosure to provide a vehicle lower part structure in which a transmission path of a collision load is secured in the event of a vehicle front or rear collision.

A vehicle lower part structure according to an aspect of the present disclosure includes:
a battery pack including a housing portion that houses a battery cell, and a cover that closes the housing portion and constitutes a floor portion of a vehicle cabin; and
a first rib that is provided on a bottom wall of the battery pack and is configured to transmit a collision load input from a vehicle front side or a vehicle rear side toward a rocker constituting a vehicle platform and extending along a vehicle front-rear direction on an outer side of the battery pack in a vehicle width direction.

The vehicle lower part structure according to the above aspect includes the battery pack and the first rib. The battery pack includes the housing portion and the cover, and the battery cell is housed in the housing portion. The cover closes the housing portion and constitutes the floor portion of the vehicle cabin. Since the floor constituting the floor portion of the vehicle cabin is constituted by the cover that closes the housing portion of the battery pack, it is not necessary to separately provide a floor panel. Thus, it is possible to reduce the number of components.

The first rib is provided on the bottom wall of the battery pack. The rocker constituting the vehicle platform extends along the vehicle front-rear direction on the outer side of the battery pack in the vehicle width direction, and the first rib transmits the collision load input from the vehicle front side or the vehicle rear side toward the rocker.

That is, in the present disclosure, the collision load (so-called front impact load or so-called rear impact load) input from the vehicle front side or the vehicle rear side can be transmitted toward the rocker via the first rib. Thus, it is possible to disperse the collision load caused by the front collision or the rear collision.

In the vehicle lower part structure of the above aspect,
the first rib may be provided on an outer side of the housing portion, and may be connected to a first coupling portion where the battery pack side and the rocker are coupled.

In the vehicle lower part structure of the above aspect, the first rib is provided on the outer side of the housing portion. Therefore, the volume of the housing portion can be increased and the battery capacity can be increased as compared with the case where the first rib is provided in the housing portion. The first rib is connected to the first coupling portion where the battery pack side and the rocker are coupled. The first coupling portion has a higher rigidity than the other portions. Therefore, the collision load transmitted by the first rib via the first coupling portion can reliably be transmitted toward the rocker.

The term “battery pack side” coupled to the rocker includes other members integrated with the battery pack, such as a bracket for coupling to the rocker and an undercover provided on the lower side of the battery cover, in addition to the case where the rocker and the battery pack are directly coupled to each other. In the description that the first rib is connected to the first coupling portion, the term “connected” includes a case where the first coupling portion is provided on a substantial extension line of the first rib in the vicinity of the first rib, in addition to the case where the first rib is integrally coupled to the first coupling portion with a bolt etc.

In the vehicle lower part structure of the above aspect,
a second coupling portion where a cross member extending in the vehicle width direction on the vehicle front side or the vehicle rear side and the first rib side are coupled and a third coupling portion where a platform member extending in the vehicle front-rear direction and the cross member are coupled may be provided at positions where the second coupling portion and the third coupling portion substantially overlap each other in the vehicle width direction in a plan view.

In the vehicle lower part structure of the above aspect, the cross member extends in the vehicle width direction on the vehicle front side or the vehicle rear side. The cross member and the first rib side are coupled via the second coupling portion. The platform member extending in the vehicle front-rear direction and the cross member are coupled via the third coupling portion. The second coupling portion and the third coupling portion are provided at the positions where the second coupling portion and the third coupling portion substantially overlap each other in the vehicle width direction in the plan view.

For example, the front impact load input in the event of the vehicle front collision is input to a front side member serving as the platform member. The front side member is coupled to the cross member via the third coupling portion. Therefore, the front impact load input to the front side member is transmitted to the cross member via the third coupling portion.

In the present disclosure, the second coupling portion where the cross member and the first rib side are coupled is provided at the position where the second coupling portion substantially overlaps the third coupling portion in the vehicle width direction in the plan view. Therefore, the front impact load transmitted to the cross member via the front side member and the third coupling portion can efficiently be transmitted to the rocker via the second coupling portion and the first rib.

The term “first rib side” coupled to the cross member includes other members integrated with the battery pack where the first rib is provided, such as a bracket for coupling to the cross member and an undercover, in addition to the case where the cross member and the first rib are directly coupled to each other.

In the vehicle lower part structure of the above aspect,
a second rib configured to transmit a collision load input along the vehicle width direction toward the rocker on an opposite side may be provided on an outer side of the housing portion on the bottom wall of the battery pack.

In the vehicle lower part structure of the above aspect, the second rib is provided on the outer side of the housing portion on the bottom wall of the battery pack. The second rib can transmit the collision load input along the vehicle width direction toward the rocker on the opposite side.

In the vehicle lower part structure of the above aspect,
the first rib and the second rib may be connected to each other.

In the vehicle lower part structure of the above aspect, the first rib and the second rib are connected to each other. Therefore, the collision load transmitted to the first rib can be transmitted to the rocker and the second rib via the first rib, and thus the collision load can be dispersed effectively.

In the description that the first rib and the second rib are connected to each other, the term “connected” includes a case where the first rib and the second rib are coupled to each other via another member such as a bracket, in addition to the case where the first rib and the second rib are integrally coupled to each other with a bolt, by welding, etc.

As described above, in the vehicle lower part structure of the present disclosure, the transmission path of the collision load can be secured in the event of the vehicle front or rear collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle lower part structure according to the present embodiment is applied, as viewed from a left obliquely upper side;

FIG. 2 is a bottom view showing a state in which a part showing a configuration of a vehicle to which the vehicle lower part structure according to the present embodiment is applied is cut away;

FIG. 3 is a schematic cross-sectional view taken along III-III line of FIG. 1; and

FIG. 4 is a schematic cross-sectional view taken along IV-IV line of FIG. 1.

### DETAILED DESCRIPTION OF EMBODIMENTS

A vehicle lower part structure according to an embodiment of the present disclosure will be described with reference to the drawings. Note that the arrow FR, the arrow UP, and the arrow LH indicated as appropriate in the drawings indicate the forward direction (traveling direction), the upward direction, and the leftward direction of the vehicle to which the vehicle lower part structure according to the present embodiment is applied. Hereinafter, when the description is made simply using terms indicating directions i.e., forward and rearward, right and left, and upward and downward, these means forward and rearward in the vehicle front-rear direction, right and left in the vehicle right-left direction (vehicle width direction), and upward and downward in the vehicle up-down direction unless otherwise specified. In addition, in the drawings, some members and some reference numerals may be omitted from the drawings in order to make the drawings easy to see.

### Configuration of Vehicle Lower Part Structure

First, a configuration of a vehicle lower part structure according to an embodiment of the present disclosure will be described.

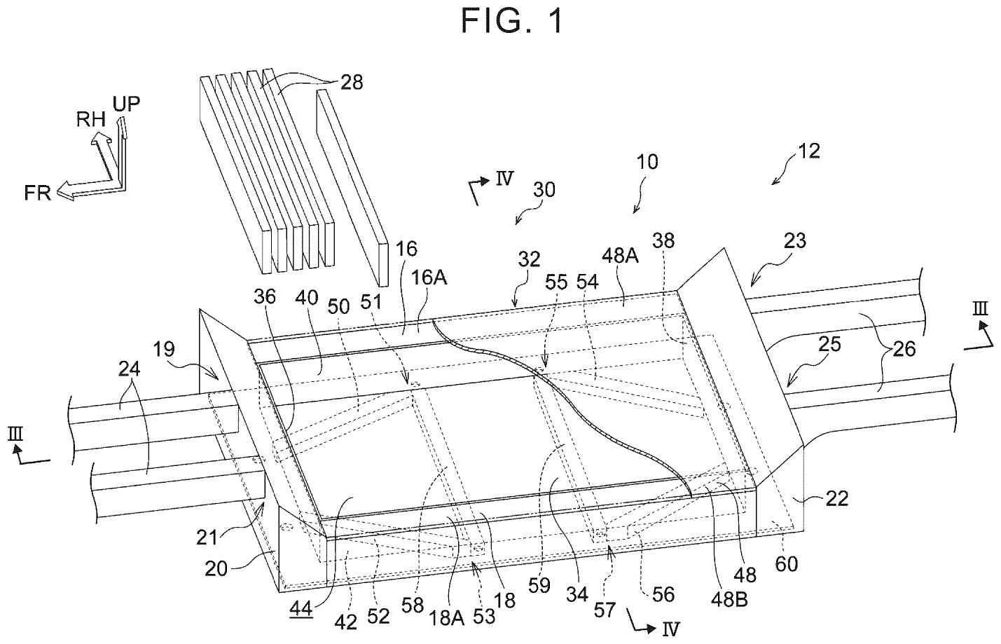

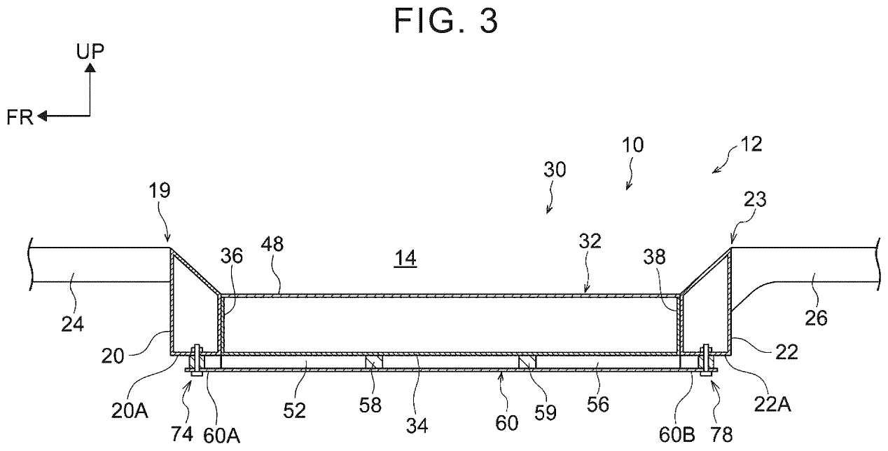

As shown in FIG. 1, the vehicle (vehicle body) 12 to which the vehicle lower part structure 10 according to the present embodiment is applied includes a pair of left and right rockers 16 and 18 each constituting a vehicle skeleton and extending along the vehicle front-rear direction at both end lower portions in the vehicle width direction of the vehicle cabin 14 (see FIG. 3), a front cross member 20 provided along the vehicle width direction at the front ends of the rockers 16 and 18, and a rear cross member 22 provided along the vehicle width direction at the rear ends of the left and right rockers 16 and 18.

On both end sides of the front cross member 20 in the vehicle width direction, rear end portions of the front side members 24 extending along the vehicle front-rear direction are coupled to each other via coupling portions (third coupling portions) 19 and 21 by bolts, welding, or the like. Further, the front end portions of the rear side members 26 extending along the vehicle front-rear direction are coupled to both end sides of the rear cross member 22 in the vehicle width direction via the coupling portions (third coupling portions) 23 and 25 by bolts, welding, and the like, respectively.

The vehicles 12 according to the present embodiment are, for example, battery electric vehicle (BEV) traveling by using a driving force of an electric motor (not shown). The lower portion of the vehicle 12 is provided with a battery pack 30 that houses a plurality of battery cells 28 that supply electric power for driving to the electric motor. The vehicles 12 may be plug-in hybrid electric vehicle (PHEV), fuel cell electric vehicle (FCEV), or the like.

Here, a configuration of a battery pack constituting a part of the vehicle lower part structure according to the present embodiment will be described.

As shown in FIG. 1, the vehicle lower part structure 10 according to the present embodiment includes a battery pack 30. The battery pack 30 is made of, for example, a light metal such as an aluminum alloy, and includes a box-shaped battery case 32 having a rectangular shape with a longitudinal direction of the vehicle in a plan view and having an upper side as an opening. In addition, a resin member such as a carbon-fiber-reinforced plastic (CFRP) or a glass-fiber-reinforced plastic (GFRP) may be used in addition to the metal. The same applies to the cover 48 and the undercover 60 described later.

The battery case 32 constituting the main body of the battery pack 30 includes a bottom wall 34, a front wall 36 erected from the front end in the vehicle front-rear direction of the bottom wall 34, a rear wall 38 opposed to the front wall 36 and erected from the rear end in the vehicle front-rear direction of the bottom wall 34, and a pair of side walls 40 and 42 erected from both ends in the vehicle width direction of the bottom wall 34 and opposed to each other.

In the present embodiment, for example, the separation distance between the front wall 36 and the rear wall 38 of the battery case 32 is formed to be slightly narrower than the separation distance between the front cross member 20 and the rear cross member 22. Further, the separation distance between the side wall 40 and the side wall 42 of the battery case 32 is formed to be slightly narrower than the separation distance between the rocker 16 and the rocker 18. Accordingly, the battery case 32 according to the present embodiment can be arranged in a space surrounded by the rockers 16 and 18, the front cross member 20, and the rear cross member 22 constituting the vehicle skeleton.

Further, a plurality of thin plate-shaped battery cells 28 having a substantially rectangular shape with the vehicle width direction as a longitudinal direction are accommodated in the housing portion 44 of the battery case 32 including the bottom wall 34, the front wall 36, the rear wall 38, and the side walls 40 and 42. The battery cells 28 are arranged along the vehicle front-rear direction. Here, the housing portion 44 is configured as one space, but the housing portion 44 may be partitioned into a plurality of spaces.

The housing portion 44 of the battery case 32 is closed by a cover 48 having a rectangular plate shape in a plan view in a state in which the plurality of battery cells 28 are accommodated. The cover 48 is made of, for example, a light metal such as an aluminum alloy, and has a plate shape in which the vertical direction of the vehicle is in the plate thickness direction, and is integrated with the battery case 32 by welding or the like, and a floor portion of the vehicle cabin 14 (see FIG. 3) is constituted by the cover 48. The front wall 36 and the rear wall 38 may be integrated with the front cross member 20 and the rear cross member 22, respectively, and the side wall 40 and the side wall 42 may be integrated with the rockers 16 and 18, respectively.

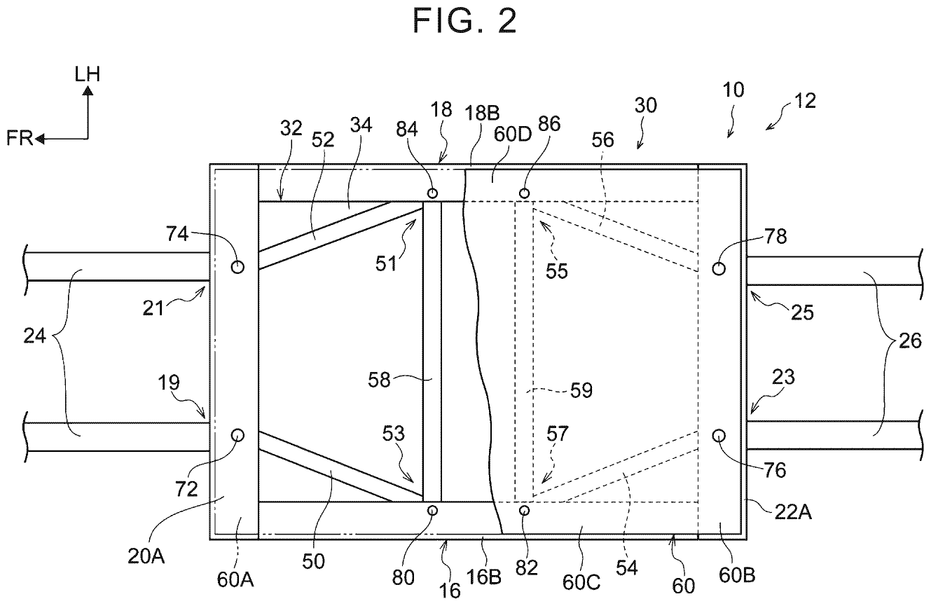

Here, as shown in FIG. 2, in the present embodiment, inclined ribs (first ribs) 50, 52, 54, and 56 and cross ribs (second ribs) 58 and 59 each having a prismatic shape are provided on the outside of the housing portion 44 in the bottom wall 34 of the battery case 32. The cross ribs 58 and 59 are provided on the center portion side of the battery case 32 in the vehicle front-rear direction, extend along the vehicle width direction of the battery case 32, and are disposed in a state of being separated from each other.

The inclined ribs 50 and 52 are provided on the front side of the battery case 32 in the vehicle front-rear direction. The inclined ribs 50 and 52 are disposed to be inclined in a direction away from each other toward the rear side in the vehicle front-rear direction. The rear end portions of the inclined ribs 50 and 52 are connected to the cross ribs 58 via joints 53 and 51 by bolts, welding, or the like, respectively.

On the other hand, the inclined ribs 54 and 56 are provided on the rear side of the battery case 32 in the vehicle front-rear direction. The inclined ribs 54 and 56 are disposed to be inclined in a direction away from each other toward the front side in the vehicle front-rear direction. The front end portions of the inclined ribs 54 and 56 are connected to the cross ribs 59 through joints 57 and 55 by bolts, welding, or the like, respectively.

The lower side of the inclined ribs 50, 52, 54, 56 and the like is provided with an undercover 60 disposed substantially parallel to the bottom wall 34 of the battery case 32. The undercover 60 is made of, for example, a light metal such as an aluminum alloy, and has a plate shape in which the vehicle vertical direction is a plate thickness direction, and has a role of preventing interference with a road surface.

As shown in FIGS. 2 and 3, the front end portion 60A of the undercover 60 is coupled to the lower wall 20A of the front cross member 20 via joints (second joints) 72 and 74 by bolts, welds, and the like. FIG. 3 is a cross-sectional view taken along III-III shown in FIG. 1.

In the present embodiment, the coupling portion 72 is provided on a substantially extended line of the inclined rib 50, and the coupling portion 74 is provided on a substantially extended line of the inclined rib 52. It should be understood that the front end portions of the inclined ribs 50 and 52 may be directly coupled to the lower wall 20A of the front cross member 20 via the coupling portions 72 and 74, respectively.

Further, in the present embodiment, the coupling portions 72 and 74 to which the undercover 60 and the front cross member 20 are coupled, and the coupling portions 19 and 21 to which the front cross member 20 and the front side member 24 are coupled are provided at positions substantially overlapping with each other in the vehicle width direction in plan view.

On the other hand, the rear end portion 60B of the undercover 60 is coupled to the lower wall 22A of the rear cross member 22 via the coupling portions (second coupling portions) 76 and 78 by bolting, welding, or the like. In the present embodiment, the coupling portion 76 is provided on a substantially extended line of the inclined rib 54, and the coupling portion 78 is provided on a substantially extended line of the inclined rib 56. It should be noted that, similarly to the coupling portions 72 and 74, the rear end portions of the inclined ribs 54 and 56 may be directly coupled to the lower wall 22A of the rear cross member 22 via the coupling portions 76 and 78, respectively.

Further, in the present embodiment, the coupling portions 76 and 78, to which the undercover 60 and the rear cross member 22 are coupled, and the coupling portions 23 and 25, to which the rear cross member 22 and the rear side member 26 are coupled, are provided at positions substantially overlapping with each other in the vehicle width direction in plan view.

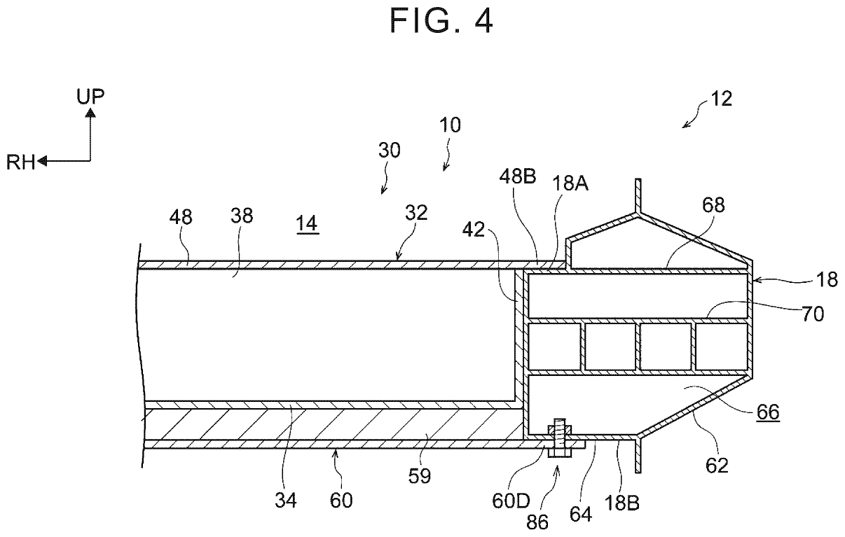

Further, one end portion 60C of the undercover 60 in the vehicle-width direction is coupled to the lower wall 16B of the rocker 16 via joints (first joints) 80 and 82 by bolts, welds, or the like. In addition, the other end 60D of the undercover 60 in the vehicle width direction is coupled to the lower wall 18B of the rocker 18 via joints (first joints) 84 and 86 by bolts, welds, and the like, similarly to the one end 60C (see FIG. 4). That is, in the present embodiment, the inclined ribs 50, 52, 54, and 56 and the cross ribs 58 and 59 are disposed between the rocker 16 and the rocker 18. Note that FIG. 4 is a cross-sectional view taken along IV-IV shown in FIG. 1, but since the rocker 16 and the rocker 18 have substantially the same configuration, only the rocker 18 side is shown in FIG. 4.

As shown in FIG. 4, the rocker 18 has a closed cross-sectional structure including a closed cross-sectional portion 66 formed by an outer portion 62 and an inner portion 64. A EA portion (shock absorbing portion) 68 formed in a straight line extending between the outer portion 62 and the inner portion 64 and an EA portion 70 formed in a ladder shape are provided in the closed cross-sectional portion 66. As described above, by providing EA portions 68 and 70 in the closed section portion 66 of the rocker 18, the side collision load inputted during the side collision of the vehicles (so-called “side collision”) can be absorbed by the plastic deformation of EA portions 68 and 70. Note that the configuration and the shape of the rocker 18 are merely examples, and are not limited to the configuration and the shape.

As shown in FIG. 2, in the present embodiment, the coupling portions 80 and 84 are provided on a substantially extended line of the cross rib 58, the coupling portion 80 is provided on a substantially extended line of the inclined rib 50, and the coupling portion 84 is provided on a substantially extended line of the inclined rib 52. In addition, the coupling portions 82 and 86 are provided on a substantially extended line of the cross rib 59, the coupling portion 82 is provided on a substantially extended line of the inclined rib 54, and the coupling portion 86 is provided on a substantially extended line of the inclined rib 56.

That is, in the present embodiment, the coupling portion 80 is provided in the vicinity of the coupling portion 53 of the inclined rib 50 and the cross rib 58, and the coupling portion 84 is provided in the vicinity of the coupling portion 51 of the inclined rib 52 and the cross rib 58. Further, the coupling portion 82 is provided in the vicinity of the coupling portion 57 of the inclined rib 54 and the cross rib 59, and the coupling portion 86 is provided in the vicinity of the coupling portion 55 of the inclined rib 56 and the cross rib 59.

In the above-described embodiment, the inclined ribs 50 and 52, the cross rib 58, and the like are provided to protrude from the outside of the housing portion 44 in the bottom wall 34 of the battery case 32. However, in the present disclosure, it is sufficient that the transmission path of the collision load can be secured at the time of the front collision or the rear collision of the vehicle, and therefore, although not shown, the inclined ribs 50, 52, the cross rib 58, and the like may be provided to protrude inside the housing portion 44.

### Operation and Effects of Vehicle Lower Part Structure

Next, the operation and effects of the vehicle lower part structure according to the present embodiment will be described.

As shown in FIGS. 1 and 2, in the present embodiment, the vehicle lower part structure 10 includes a battery case 32 and inclined ribs 50, 52, 54, and 56. The battery case 32 includes a housing portion 44 and a cover 48, and the housing portion 44 is accommodated in a state in which the battery cells 28 extend along the vehicle width direction and are arranged along the vehicle front-rear direction. The cover 48 closes the housing portion 44 and constitutes a floor portion of the vehicle cabin 14.

As described above, in the present embodiment, since the floor constituting the floor portion of the vehicle cabin 14 is configured by the cover 48 that closes the housing portion 44 of the battery case 32, it is not necessary to separately provide the floor panel, and thus it is possible to reduce the number of components.

Here, the inclined ribs 50, 52, 54, and 56 are provided on the bottom wall 34 of the battery case 32. Rockers 16 and 18 constituting a part of the vehicle skeleton extend along the vehicle front-rear direction outside the battery case 32 in the vehicle width direction. The inclined ribs 50 and 52 transmit the collision load input from the vehicle front side to the rockers 16 and 18 side, and the inclined ribs 54 and 56 transmit the collision load input from the vehicle rear side to the rockers 16 and 18 side.

That is, in the present embodiment, the inclined ribs 50 and 52 and the inclined ribs 54 and 56 are provided in the bottom wall 34 of the battery case 32, so that the transmission path of the collision load (so-called front collision load, so-called rear collision load) input from the vehicle front side and the vehicle rear side is secured, and the collision load caused by the front collision or the rear collision can be dispersed.

In addition, in the present embodiment, the inclined ribs 50, 52, 54, and 56 are provided outside the housing portion 44. Accordingly, in the present embodiment, although not illustrated, the volume in the accommodation portion 44 can be increased as compared with the case where the inclined ribs 50, 52, 54, and 56 are provided in the housing portion 44, and the battery capacity can be increased. Incidentally, the inclined ribs 50, 52, 54, and 56 may be provided in the housing portion 44, and in this case, the rigidity of the battery case 32 itself can be improved.

Here, in the present embodiment, the inclined ribs 50, 52, 54, and 56 provided on the bottom wall 34 of the battery case 32 are connected to the coupling portions (first coupling portions) 80, 84, 82, and 86 to which the battery case 32 side and the rockers 16 and 18 are coupled, respectively.

Specifically, the coupling portion 80 is provided in the vicinity of the coupling portion 53 of the inclined rib 50 and the cross rib 58 on a substantially extended line of the inclined rib 50. The coupling portion 84 is provided in the vicinity of the coupling portion 51 of the inclined rib 52 and the cross rib 58 on a substantially extended line of the inclined rib 52. Further, the coupling portion 82 is provided in the vicinity of the coupling portion 57 of the inclined rib 54 and the cross rib 59 on the substantially extended line of the inclined rib 54. The coupling portion 86 is provided in the vicinity of the coupling portion 55 of the inclined rib 56 and the cross rib 59 on the substantially extended line of the inclined rib 56.

In general, a coupling portion to which members are coupled is more rigid than other portions. Therefore, in the present embodiment, with the above-described configuration, the collision load transmitted by the inclined ribs 50 and 54 via the coupling portions 80 and 82 can be reliably transmitted to the rocker 16 side. In addition, the collision load transmitted by the inclined ribs 52 and 56 via the coupling portions 84 and 86 can be reliably transmitted to the rocker 18 side.

Further, in the present embodiment, the front cross member 20 and the rear cross member 22 extend in the vehicle width direction on the vehicle front side and the vehicle rear side, respectively. The front cross member 20 and the undercover 60 are coupled to each other via coupling portions (second coupling portions) 72 and 74. The front cross member 20 and the front side member 24 are coupled to the coupling portions (third coupling portions) 19 and 21.

Here, in the present embodiment, the coupling portions (second coupling portions) 72 and 74 are provided at positions substantially overlapping the coupling portions 19 and 21 in the vehicle width direction in plan view. The rear cross member 22 side is also the same as the front cross member 20.

For example, at the time of the front collision of the vehicle, the input front collision load is input to the front side member 24 as the skeleton member. Since the front side member 24 is coupled to the front cross member 20 via the coupling portions 19 and 21, the front impact load input to the front side member 24 is transmitted to the front cross member 20 via the coupling portions 19 and 21.

In the present embodiment, the coupling portions 72 and 74 to which the front cross member 20 and the undercover 60 are coupled are provided at positions substantially overlapping the coupling portions 19 and 21 in the vehicle width direction in plan view. Therefore, the front collision load transmitted to the front cross member 20 via the front side member 24 and the coupling portions 19 and 21 can be efficiently transmitted to the rockers 16 and 18 via the coupling portions 72 and 74 and the inclined ribs 50 and 52 provided on the bottom wall 34 of the battery case 32, respectively.

In the present embodiment, cross ribs 58 and 59 extend along the vehicle width direction of the battery case 32 on the bottom wall of the battery case 32. Since the cross ribs 58 and 59 are disposed between the rocker 16 and the rocker 18, the collision load input along the vehicle width direction can be transmitted to the rocker side on the opposite side.

Further, in the present embodiment, the inclined ribs 50 and 52 are connected to the cross rib 58, and the inclined ribs 54 and 56 are connected to the cross rib 59. Accordingly, in the present embodiment, the collision load transmitted from the vehicle front side to the inclined ribs 50 and 52 can be transmitted to the rockers 16 and 18 and the cross ribs 58 via the inclined ribs 50 and 52, and thus the collision load can be effectively distributed. Further, in the present embodiment, the collision load transmitted from the vehicle rear side to the inclined ribs 54 and 56 can be transmitted to the rockers 16 and 18 and the cross ribs 59 via the inclined ribs 54 and 56, so that the collision load can be effectively distributed.

### Additional Remarks

Note that the vehicle lower part structure according to the present disclosure may be formed by appropriately combining the following configurations.

### Configuration 1

In the vehicle lower part structure, a battery pack including a housing part in which a battery cell is accommodated and a cover which closes the housing part and constitutes a floor part of a vehicle cabin, and a first rib provided on a bottom wall of the battery pack and configured to transmit a collision load input from a vehicle front side or a vehicle rear side to a rocker side that constitutes a part of a vehicle skeleton and extends along a vehicle front-rear direction outside the battery pack in the vehicle width direction.

### Configuration 2

The first rib is provided on an outer side of the housing portion, and is connected to a first coupling portion to which the battery pack side and the rocker are coupled.

### Configuration 3

A cross member extending in the vehicle width direction on the vehicle front side or the vehicle rear side and a second coupling portion in which the first rib side is coupled, and a third coupling portion in which the skeleton member extending in the vehicle front-rear direction and the cross member are coupled are provided at positions substantially overlapping in the vehicle width direction in a plan view.

### Configuration 4

A second rib that transmits the collision load input along the vehicle width direction to the rocker side on the opposite side is provided on the outside of the housing portion in the bottom wall of the battery pack.

### Configuration 5

The first rib and the second rib are connected to each other.

In addition, the present disclosure can be implemented with various modifications without departing from the scope of the disclosure. Further, it goes without saying that the scope of rights of the present disclosure is not limited to the above-described embodiment.

What is claimed is:

1. A vehicle lower part structure comprising:
a battery pack including a housing portion that houses a battery cell, and a cover that closes the housing portion and constitutes a floor portion of a vehicle cabin; and
a first rib that is provided on a bottom wall of the battery pack and is configured to transmit a collision load input from a vehicle front side or a vehicle rear side toward a rocker constituting a vehicle platform and extending along a vehicle front-rear direction on an outer side of the battery pack in a vehicle width direction.

2. The vehicle lower part structure according to claim 1, wherein the first rib is provided on an outer side of the housing portion, and is connected to a first coupling portion where the battery pack side and the rocker are coupled.

3. The vehicle lower part structure according to claim 1, wherein a second coupling portion where a cross member extending in the vehicle width direction on the vehicle front side or the vehicle rear side and the first rib side are coupled and a third coupling portion where a platform member extending in the vehicle front-rear direction and the cross member are coupled are provided at positions where the second coupling portion and the third coupling portion substantially overlap each other in the vehicle width direction in a plan view.

4. The vehicle lower part structure according to claim 1, wherein a second rib configured to transmit a collision load input along the vehicle width direction toward the rocker on an opposite side is provided on an outer side of the housing portion on the bottom wall of the battery pack.

5. The vehicle lower part structure according to claim 4, wherein the first rib and the second rib are connected to each other.
